(19) United States
(12) Patent Application Publication
(10) Pub. No.: US 2022/0083981 A1
(43) Pub. Date: Mar. 17, 2022

(54) MANAGING COMPLEX RESOURCE ALLOCATION WITHIN AUTOMATED SYSTEMS

(71) Applicant: DC Plan Insurance Solutions, LLC, Fargo, ND (US)

(72) Inventors: Matthew B. Schoen, Austin, TX (US); Wayne Perg, Sierra Vista, AZ (US)

(21) Appl. No.: 17/475,452

(22) Filed: Sep. 15, 2021

Related U.S. Application Data
(60) Provisional application No. 63/078,348, filed on Sep. 15, 2020.

(51) Int. Cl. G06Q 10/10; G06Q 30/02

(52) U.S. Cl. CPC G06Q 10/1057; G06Q 30/0283

(57) ABSTRACT

The present invention is directed to methods, systems, and interfaces for managing accounts and assets having complicated effects and relationships, including underwriting, specification, administering, updating, servicing and comparison of contingent deferred income annuity contracts for protecting retirement income from diminishment due to the occurrence of at least one pre-retirement risk that may result in loss, reduction or suspension of pension contributions by participants in retirement plans and owners of individual retirement plans.

### CROSS-REFERENCE TO RELATED APPLICATIONS

This application claims the priority benefit of U.S. Provisional Application Ser. No. 63/078,348, filed Sep. 15, 2020, the entire disclosure of which is incorporated by reference in its entirety.

### BACKGROUND

Modern investment systems, such as those used by corporations, individuals, and other entities to create and manage retirement funds, are increasingly reliant on complex computer systems. As a result, human users may have difficulty or be completely unable to appreciate the effects of decisions made with respect to such investment accounts on behalf of those users. As a specific example, it may be difficult for a typical consumer of retirement and/or insurance plans to forecast with any accuracy what benefits they will receive from such plans if various scenarios do or do not occur due to the computational complexity that determine those benefits.

### BRIEF DESCRIPTION OF THE DRAWINGS

FIGS. 1 and 1A show a flow chart for an illustrative embodiment disclosed herein.

FIGS. 2 and 2A show a flow chart for an illustrative embodiment disclosed herein

FIGS. 3, 3A, and 3B show a flow chart for an illustrative embodiment disclosed herein.

FIG. 4 shows representation of a screen on an illustrative graphical user interface (GUI) according to embodiments disclosed herein.

### DETAILED DESCRIPTION

Many modern computing systems operate automatically or semi-automatically after an initial set-up that may not require much or any involvement from an end user. As such, it may be difficult for human users to understand fully the status, management, options, or effects of accounts that may be managed on behalf of the user. This may be especially true when such systems manage accounts that may interact in ways that are not immediately apparent to the user and/or that have complex interactions among one another that may not be fully appreciated by the user. As a particular example, accounts that relate to obligations or rights of the user may be difficult for user to understand without assistance, such as where multiple financial accounts may have overlapping benefits, obligations, or rights for the user. As a specific example, it may be difficult for a typical consumer of retirement and/or insurance plans to forecast with any accuracy what benefits they will receive from such plans if various scenarios do or do not occur. Other systems also may benefit from embodiments disclosed herein, such as smart contracts and especially complex, interdependent smart contracts that involve multiple parties. For example, such systems may allow for automated arrangements such as in the case where Party A fails or fails to perform an obligation under a computerized smart contract, Party B is obligated to step into Party A's shoes or Parties B, C and D have pre-agreed to assume a stipulated portion or are apportioned their share based on pre-defined criteria. Other arrangements may be used, up to any desired level of complexity, which may not reasonably be managed or readily understood by a human user without use of embodiments disclosed herein.

For these and other reasons, there is a need for a method, system and user interface to manage such accounts and related goods and services in a way that makes them easy for the user to understand while still maintaining all the underlying features of the accounts. Embodiments disclosed herein are described with respect to the example of contingent deferred income annuity contracts, where such contracts may protect against diminished retirement income resulting from pre-retirement risk faced by retirement plan participants and owners of individual retirement accounts. It will be understood that the same or equivalent systems, methods, and interfaces may be used to manage other types of accounts while achieving the same benefits for end users.

Modern computerized retirement and investment systems provide several examples of such complex, automated or semi-automated systems. As defined benefit pension plans continue to shrink as a source of retirement income, more Americans are relying on retirement plans in which the amount of retirement income is a function of the amounts of the contributions made by the participant in the plan over the working life of the participant together with the returns earned those contributions before retirement and the returns earned on the accumulated assets subsequent to retirement—e.g., various forms of defined contribution pension plans, including 401k plans, and individual retirement plans.

In general, the source of the contributions to the plan is the income earned by the participant—i.e., the labor or work income generated by the participant. Any event that interrupts this labor income—e.g., disability, unemployment, care-giving for a loved one, etc.—may cause losses in contributions (in whole or in part) for a period of time, which in turn reduces future retirement income. The amount of the reduction in retirement income is greater than the loss in amounts of contributions due to the foregone investment earnings both before and after retirement.

At least some of the factors that may lead to a loss of contributions are insurable risks—e.g., disability, unemployment. Other factors fall outside established insurable risks, e.g., acting as caregiver for a loved one suffering from a debilitating disease or accident.

Certain individuals with earned income are eligible to make contributions to various individual retirement accounts and individual retirement annuities. Eligibility rules differ depending upon the type of individual retirement account. For example, generally, anyone under the age of 70½ who earns income from employment may make contributions to a traditional individual retirement account (IRA). For a Roth IRA, contributions may be made as long as the individual has earned income and a modified adjusted gross income below certain thresholds. Each eligible person may contribute up to a permitted maximum which is subject to periodic adjustments. Contributions to traditional IRAs may be tax-deductible for federal income tax purposes when certain conditions are met. Roth IRA contributions are not deductible for federal income tax purposes. Traditional IRA distributions may start after age 59½ and must start no later than age 70½. Withdrawals made prior to age 59½ are permitted but generally subject to a penalty tax. Both traditional and Roth IRAs are primarily intended as retirement savings accounts.

Individuals who are relying upon IRAs as a primary source of retirement income are generally the same people depending upon social security as another prime source of retirement income. Stated differently, people who work for employers sponsoring qualified retirement plan(s) are less dependent upon social security or IRAs for retirement income than people who work for employers offering no retirement plan(s). There is a need to assure that targeted savings at retirement are not jeopardized or lessened due to unforeseen circumstances such as disabilities.

Additionally, many employer-sponsored qualified retirement plans provide employee participants certain safeguards with respect to the amount of retirement benefits available at retirement. For example, defined benefit pension plans are retirement plans with employer contributions aggregated annually based upon an actuarially determined plan liability. Current contributions are generally based upon estimates of future employee income levels immediately prior to retirement (e.g., 50% of the final five years' average gross salary) and other actuarial factors such as estimated rates of return on plan assets, liability discount rates, employee turnover, mortality and morbidity. In contrast, benefits under defined contribution plans are based upon individual accounts. Hybrid or Cash Balance Retirement Plans are defined benefit plans with hypothetical or notional individual accounts.

Many defined benefit plans provide a disability protection provision. In the event the employee plan participant becomes disabled prior to retirement, the plan continues to accrue benefits as though the employee continued active employment. Hence, the income payable at retirement approximates the retirement income benefit payable had disability not interrupted the active employment of the plan participant.

Defined contribution plans such as 401(k) plans and non-traditional defined benefit plans such as cash balance plans are becoming increasingly popular. These plans are beginning to offer new forms of protection to disabled employees as well. U.S. Pat. No. 6,235,176 discloses a method for making such coverage more widely available.

Private disability coverage, whether sponsored by employers or purchased directly by individuals have overall coverage limitations. Generally, the available coverage is limited to no more than 66⅔% of gross earned income. Insurance companies are reluctant to provide a higher percentage of coverage due to the risk that a disabled insured will have insufficient economic incentive to go back to work. Often, the percentage of gross earned income covered is considerably lower than 66⅔%. This is because there are generally upper limitations on the amount of compensation covered (expressed in dollars, e.g., $200,000) or because only certain types of income are covered under disability policies (e.g., employer sponsored group long term disability insurance often excludes incentive compensation, commission income and other non-salary compensation from the definition of covered income). Because people who have private disability coverage are likely to receive 66⅔% or less of pre-disability income during disability, they are unlikely to be able to continue contributing to IRAs at pre-disability levels without worsening their present financial hardship.

Of course, millions of Americans have no private disability coverage at all, and social security provides a modest disability benefit, but has an extremely difficult definition of disability qualification to meet. Continuing IRA contributions at pre-disability levels will likely be the least of the financial worries for those who do not own private disability insurance.

Currently, insurance or benefits designed to make up for lost contributions (and the earnings thereon) to traditional IRAs or Roth IRAs resulting from the disability of individual account holders does not exist. There are no known products (insurance or other) on the market that provide this benefit.

Traditional disability income policies pay benefits during the time the person is disabled. Traditional policy designs that pay benefits during the period of disability necessitate disability benefits being paid either; 1) directly to the disabled IRA participant; 2) into the IRA of the disabled participant, or, 3) into some other accumulation vehicle. The purpose of the desired coverage is to prevent diminishment of retirement benefits that would have been accumulated or received had a disability not occurred. It is undesirable for the benefits to be at the immediate disposal or discretion of the disabled participant when the disability occurs. Firstly, the combined coverage may exceed the intended maximum of the insurance company or other benefit provider. For example, as stated previously, most insurers offering individual or group Long Term Disability (LTD) insurance seek to avoid coverage exceeding 66⅔% of compensation. Also, the participant may use the benefit on current expenses and, consequently still suffer diminishment of retirement benefits.

There is a danger that the participant will squander benefits prior to retirement even if the benefit is payable to the IRA instead of to the participant because disabled participants are able to access IRA plan assets prior to age 59½ without excise tax in the event of the disability the IRA owner.

Making the benefit payable to a trust, annuity or other asset accumulation instrument may address this problem. The vehicle must possess the necessary restrictions on withdrawals prior to retirement to assure benefits are ultimately available at retirement. If this approach is used, the applicable taxation of the accumulation vehicle must be taken into consideration. Traditional IRA contributions are sometimes deductible. In addition, the growth (income and gains) of invested contributions is not subject to income taxation until distribution. If the disability benefit is contributed into a vehicle with either nondeductible contributions or currently taxable investment growth, the participant will suffer diminishment of retirement benefits. Because each participant's income tax bracket and situation may differ, this raises an almost infinite number of necessary corrective adjustments to offset the cost of taxes. Deferred annuities are not subject to income taxation on growth until distribution. However, in order for an annuity to completely avoid diminishment, the disability benefit must be grossed up so that the net after tax benefit matches the pre-disability contribution amount (an infinite number of possible corrections). If the disability benefit is paid into a deferred annuity on a tax-free basis, adjustments for non-deductibility may not be necessary. An annuity may also be desirable because some deferred annuities allow contract owners to direct investment options. This may allow the disabled participant to control annuity investment allocations in a fashion similar to IRA plans. However, there are practical economic drawbacks to all of these approaches. Given that the maximum annual IRA contribution for an individual is far lower than under most employer sponsored retirement plans such as 401(k) plans, the cost of having dollars flowing into either a trust or annuity with special restrictions, is likely to be prohibitive in relation to the benefit. This may set the stage for a lack of availability of such a plan in connection with IRAs today. Plans using this approach are available in connection with replacing lost contributions to private pension plans (where the annual contribution limits are approximately five times higher than for IRAs).

A possible alternative to deferred annuities or other accumulation vehicles that contain restrictions on plan withdrawals prior to retirement, is the disability policy or benefit itself. In order to avoid the diminishment risk described in the proceeding paragraphs, a disability policy or benefit would have to be designed with disability benefit payouts deferred until retirement or other specified time. Additionally, the policy must provide a method of making up for lost asset growth on contributions or hypothetical contributions. This might be accomplished in a number of ways. The policy or benefit could have a stated asset growth rate that the insurance company accrues on contributions and account balances until retirement (at the insurance company's risk). For example, the policy may promise that the annual contribution and account balance will grow at a specified rate (e.g., 8% per annum). If the insurance company earns less than 8% on its reserves, they are still obligated to pay benefits at 8%. If it earns more than the stipulated minimum return, it may either keep the excess return as profit (non-participating policy) or share the excess return with policy-owners in the form of dividends (a participating contract). Instead of a fixed rate of growth, the rate credited to accrued contributions and account balances may be tied to a published index such as a United States Treasury Bond Index or the Standard & Poors 500 Index. Once again, the insurance company may take the risk associated with delivering benefits at the promised growth rate and may issue the policy either on participating or non-participating basis. All of the designs mentioned thus far are examples of general account policies. All policy reserves are held within the general account of the insurance company and are general obligations of the insurance company. Insurance companies might also design a disability policy with policy reserves held in a separate account. The benefit obligations of these policies are supported by the underlying assets held within the separate account and is not a general obligation of the insurance company. Assets held in the separate account are reserved for the exclusive benefit of policyholders and are not chargeable with any other obligation of the insurance company. Annual accrued benefit contributions and account balances within both general account policies and separate account policies may be allocated by participants (generally, among several investment divisions). Under this approach, the investment risk associated with investment performance is borne primarily by each disabled participant (as opposed to the insurer).

Individuals can voluntarily purchase the various disability policy or benefit designs described above or coverage may be made available on some other basis. The financial institution offering a particular IRA product could offer the feature at no charge as a means of competing against other commercial IRA providers. Investment product vendors such as mutual fund companies may incorporate a disability completion feature within certain mutual funds and absorb the cost of providing the feature. They can also offer the feature as an optional benefit and charge higher fees. Insurance companies might provide an annuity with a similar feature or rider and either charge an additional fee or premium or absorb the cost. Employers might pay for a benefit, either insured or otherwise, on the behalf of employees. This is more likely in those situations where an employer makes an IRA available to employees under a payroll deduction plan or on some other sponsored basis.

The form or design of coverage or benefits can vary greatly. Group or individual disability policies may be used. It may be offered through a rider to some other form of insurance policy. The benefit may be provided as an implicit feature or provision of an account or other investment vehicle. The investment vehicle or account in turn might purchase insurance to indemnify all or a portion of the risk. Benefits can be paid in installments or in a lump sum.

Because there are currently no known disability policies or benefits on the market that defer disability benefit payments until retirement (or early retirement), there are no known computer software systems in existence (with the exception of the above-referenced U.S. Pat. No. 6,235,176) to track deferred disability payments, benefits, account balances, reserves or obligations. There are no known computer software systems available to track the growth or hypothetical growth of deferred disability benefits at either fixed rates or rates tied to indices with the risk for attaining such growth borne by the insurance companies (either with a participating policy or a non-participating policy), reinsurance companies, mutual fund companies or any other company. There are currently no known systems available to track the growth of deferred disability benefits with the growth of the deferred disability benefits tied to investment options selected by the disabled participant with the investment risk borne by the participant. There are no known computer software systems that calculate reserves, profits, losses, loss ratios, liabilities, or other actuarial factors for disability policies or benefits with benefits deferred until retirement or other specified period. There are no known computer software systems designed for primary insurance companies (insurance companies issuing the deferred disability policy) designed to interact on an automated basis with the computer software systems of reinsurance companies reinsuring deferred disability coverage. There are no known computer software systems available to provide accounting, record keeping or other administrative processes to insurance companies, reinsurance companies, mutual fund companies or any other company desiring to offer disability policies with benefits that are deferred until retirement or early retirement. As previously disclosed, the lack of any system, method, or interface to track these and other attributes of complex accounts may make it difficult or impossible for typical participants in such accounts to understand their rights and benefits under a combination of such plans. Similarly, it may be difficult for individual users of the existing management systems, such as individual advisors in an insurance or retirement company to understand fully the interactions of such accounts so as to, for example, competently advise their own customers.

U.S. Pat. No. 6,235,176 identified a need for disability coverage protecting retirement benefits of individual participants within certain defined contribution retirement plans and disclosed that it may in some instances be preferable to provide such coverage on a deferred basis (deferred until retirement or early retirement). Other than embodiments disclosed herein, there has not been an appreciation in the art for other potential needs to defer the payment of disability benefits until retirement or early retirement in connection with retirement plans. Many employers offer two or more retirement plans to employees. In such cases, the employer may wish to provide coverage to protect the contributions made on behalf of individual participants who are participants in more than one plan. In such cases, it may be undesirable to purchase two or more separate policies (one in each of the plans for each participant. This would likely involve unnecessary duplication of certain expenses such as policy administration fees. It would be more economical to purchase a single policy covering all contributions, or an approximation of all contributions made on behalf of a single participant in two or more retirement. Payment of such consolidated coverage at the time of disability may not always comply with funding limitations for the selected plan. Therefore, it may be necessary to pay such benefits directly to the participant at retirement or early retirement (or the accrued benefit to a beneficiary in the event the participant dies during such period). In making the subsequently discussed invention, we believe that we are the first to have discovered this need or problem.

In recent years, politicians and others have opined that the current U.S. social security retirement system is heading toward fiscal crises. Some believe that the financial danger is attributable to both the changing demographics of the working population (the ratio of people who are employed to the people who are receiving social security retirement benefits has been steadily dropping for decades) and the low investment performance of current social security plan assets.

Historically, social security has not maintained or administered individual retirement accounts. Rather, aggregate plan liabilities determine aggregate funding goals.

In the past several years, there have been several federal legislative proposals to reform the U.S. social security retirement system. Among these proposals are plans calling for the establishment of individual social security retirement accounts. Under one proposal, workers would be able to select investment options by filling out forms filed with their taxes. Although such plans are not yet in operation for U.S. workers, the present invention is useful for such accounts for workers of those nations that currently provide social security retirement plans with individual plans, and of course the computing for such accounts can be carried out anywhere (such as in the United States).

Considering the future financial problems of the current U.S. social security retirement system, legislation reforming the current system seems almost unavoidable. Currently, social security disability benefits are not based on individual retirement accounts. If legislation is passed that includes the establishment of individual social security retirement accounts, there will be an analogous need for entirely new type(s) of disability benefits protecting retirement benefits. (Note that the present disclosure is directed to computing operations, such that a particular embodiment of the invention and program code and/or data may reflect changeable but readily discernable matters from whatever facts or law may be applicable, U.S. or otherwise.)

There are many possible ways of preserving individual social security retirement account benefits in the event of disability.

In the case of individual social security retirement accounts, the cost and amount of coverage and benefits may be calculated individually based upon individual contributions or individual account balances. The cost of the benefit may be charged according to individual coverage amounts or may be assessed according to other factors. It may be insured through private insurance companies or self-insured by the Social Security Administration (used herein as an example but intended to encompass the like). If self insured, it may be self-insured through the establishment of a special fund or reserve or the risk can be borne by the system in some other fashion. The Social Security Administration might purchase insurance to indemnify all or a portion of the risk. If insured by private insurance companies, a group policy might be used. Benefits may be deferred until normal retirement or be payable at a special early retirement date. It is possible that both current and deferred benefits may be offered. Current and or deferred benefits might be linked to other social security disability benefits or may be calculated and funded separately.

An object of the present invention is to address the issues discussed above with technological modifications that enable management of complex user accounts and, in particular, that enable contingent deferred income annuity contracts that protect against diminishment of retirement income resulting from losses in contributions associated with various pre-retirement risks faced by participants in retirement plans and owners of individual retirement plans. The technological modifications enable the underwriting and specification of the contingent deferred income annuity contracts; the administration, updating and servicing of the contracts over extended periods, in many instances, several decades; and the provision of easily-understood representations of such contracts, as well as their relationship to other accounts such as the related retirement accounts, to end users.

For example, technological modifications disclosed herein may enable the underwriting and specification of a contingent deferred income annuity contract protecting at least one participant of at least one retirement plan or at least one owner of at least one individual retirement plan from diminishment of retirement income due to the occurrence of at least one qualifying event wherein the deferred income annuity payments are contingent upon the occurrence of at least one qualifying event that would cause loss, reduction, or suspension of retirement plan contributions. Examples of potential qualifying events that would cause loss, reduction, or suspension of retirement plan contributions include, but are not limited to, long-term disability and unemployment. The amounts of the contingent deferred income annuity payments may be a function of, amongst other variables, the timing and/or the duration of the qualifying event. Current systems are unable to provide such underwriting and/or specification because, among other limitations, the variables that can impact individually underwriting each contract are more numerous and multi-faceted than other coverages for similar amounts at risk. Stated differently, only very large amounts of coverages (with correspondingly large premiums) applied for by a single individual would provide sufficient economic incentive for an insurer to undertake the bespoke underwriting process, which would by definition involve many decisions and decision points to be made and documented outside the system. It has not been possible previously to automate, on a fully computerized system including conventional insurance and other risk analysis systems, the number and proper sequence of underwriting steps to provide instantaneous quotes based on actual risk factors—especially for such small amounts of coverage on so many lives.

In some embodiments, the administration, updating and servicing of the specified contingent deferred annuity contract may take place over an extended period that may span multiple decades.

In an embodiment, a graphical user interface (GUI) may be used for multiple purposes as disclosed herein. In fact, a GUI based system may be a necessity for owners of individual retirement plans because they must be individually underwritten, even though the amount of coverage per person is relatively small. Stated differently, there is no employer plan sponsor acting as intermediary between those making coverage available and individuals in need of coverage; ergo, no aggregate census information with contribution data, generally no collective access to potential buyers, no combined purchasing power, no intermediary with the ability to deduct premiums from wages based on known coverage needs, no intermediary to pay for the coverage on behalf of all annuitants, no intermediary to automatically enroll classes of employees into the benefit plan or to make it available on an elective basis, a non-elective basis or a combination of elective and non-elective. Consequently, without a GUI based system as disclosed herein, insurers cannot make coverage available in a cost-effective manner. A GUI may be useful to end users and other users of the systems disclosed herein at every phase; for example, a GUI may be used to educate retirement plan owners about the risk, both generically and the particular ramifications for each unprotected plan owner, in a manner that is easily understood by the plan owner. As another example, in some embodiments a GUI may be the only practical way for collecting inputs for pre-application modeling and pre-application underwriting and, accordingly, may be the most optimal way of delivering and displaying to prospective buyers a plurality of product premium quotes based on each applicant's individual risk profile. Similarly, in some embodiments a GUI may be the only reasonably viable interface for facilitating partially underwritten product comparisons by allowing applicants to efficiently contrast and compare offerings because it first allows a plurality of insurers to formulate premium quotations based on an individual risk profile based on information provided by and attested to by the applicant; this in turn protects the applicant from pursuing ultimately undesirable product(s) that might pre-underwriting, appear to be highly competitive (i.e., insurer quotes that are based solely on broad based assumptions will often skew the results in favor of an insurer that might, after underwriting the actual risk, be among the least competitive). In short, making coverage available to millions of individual retirement plan owners may be improved or enabled by a GUI as disclosed herein with many features that have never existed. Examples include but are not limited to, a GUI for the display of comparisons of projected deferred income annuity payment amounts conditional upon the occurrence of at least one qualifying event for at least one participant of at least one retirement plan, or at least one qualifying event, wherein the GUI display may include a display of certain data inputs used in determining the projected comparison amounts. The data inputs displayed on the GUI display may include, but are not limited to: personal data inputs, economic scenario inputs, other underwriting inputs, and comparison inputs. The data inputs displayed on the GUI may include the ability to “click through” to increasing levels of detail regarding the data inputs. The system may further include the ability to modify one or more inputs and determine a revised comparison which is then displayed on the GUI.

Embodiments disclosed herein may enable the determination and display of projected retirement income amounts other than said determined deferred annuity payments contingent upon the occurrence of at least one qualifying event.

The graphical comparisons of determined outputs may be over a specified range or ranges of at least one input variable including, but not limited to: 1) a range of occurrences of at least one qualifying event; 2) a range of economic scenarios; 3) a range of future income scenarios; 4) a range of future interest or asset growth rates; and, 5) a range of future performance of one or more market indices.

In an embodiment, the graphically displayed comparison of determined outputs may take the form of total projected retirement broken down into: 1) deferred income annuity payment amounts conditional upon the occurrence of at least one qualifying event for at least one participant of at least one retirement plan, or at least one qualifying event for at least own owner of at least one individual retirement plan; and, 2) projected retirement income amounts other than said determined deferred annuity payments contingent upon the occurrence of at least one qualifying event.

The graphical user interface display (GUI) may include, in addition to the graphical comparison of projected retirement income amounts, a display of personal data input for an individual (actual or hypothetical) for whom the comparison is determined. If the comparison is being created for a specific individual, the current and historical data for the individual may be populated through a link to one or more databases containing the relevant information. If the comparison is being created for a hypothetical individual, the data may be populated through a link to a database of example individuals or by a custom creation of the data for the hypothetical individual, or a combination of the two.

Regardless of whether the comparison is being created for an actual individual or a hypothetical individual, the personal data may be broken down into two components: 1) current and historical data; and, 2) projected future data (e.g., projected future income, projected time of future retirement, etc.). The projected future data may be created through a variety of means, including, but not limited to: 1) custom entry of the projected future data; 2) projection engines that generate projected future data from the historical data using assumed future economic and financial data and/or a variety of pre-programmed alternative scenarios; and, 3) a combination of custom entry and projection engines.

The GUI may include the ability to “click through” to sub-menus and associated displays of increasing detail regarding the personal data input. These sub-menus and associated displays may include the ability to alter the input data. In the event that projection engines are utilized in determining the projected future data, the sub-menus may include specifications of the projection engine(s) and/or the ability to alter elements of the specification(s) for the engine(s).

The GUI may further include a display of an economic scenario input defining the current and projected economic variables (including all relevant market, interest rate and rates of return data) which were used in determining the comparison. If the comparison is being created as of a current or historical date, the current and historical economic data may be populated through a link to one or more databases containing the relevant information. If the comparison is being created for a hypothetical current economic scenario, the data may be populated through a link to a database of hypothetical current economic scenarios, by a custom creation of the data for the hypothetical current economic scenario, or a combination of the two.

Regardless of whether the comparison is being created for an actual current or historical economic scenario or a hypothetical current economic scenario, the economic scenario data may be broken down into two components: 1) current and historical economic scenario data—actual or hypothetical; and, 2) projected future economic scenario data. The projected future economic scenario data may be created through a variety of means, including, but not limited to: 1) custom entry of the projected future data; 2) economic scenario projection engines that generate projected future data from the historical (actual or hypothetical) economic scenario data using an economic model with stochastic inputs; and, 3) a combination of custom entry and economic scenario projection engines.

The GUI may include the ability to “click through” to sub-menus and associated displays of increasing detail regarding the economic scenario data input. These sub-menus and associated displays may include the ability to alter the input data. In the event that economic scenario projection engines are utilized in determining the projected future data, the sub-menus may include specifications of the projection engine(s), the ability to generate Monte Carlo analysis results according to specified percentile results, and/or the ability to alter elements of the specification(s) for the economic scenario projection engine(s).

In some embodiments, the GUI may include a display of a comparison of inputs including, but not limited to: 1) identifying the variety of contract used to generate the first alternative; 2) identifying the variety of contract used to generate the second alternative; 3) other underwriting inputs impacting the underwriting and/or performance of each alternative: and, 4) timing and duration of occurrence(s) of a qualifying event.

Other underwriting inputs may include insurance company specific factors. In the event that a comparison involves a comparison of contracts to be underwritten by different insurance companies, differences in these insurance company specific factors may impact the determined comparison. Insurance company specific factors may include, but are not limited to: 1) risk factors—e.g., assessments of the mean and variability of probability distributions of occurrences of a qualifying event; 2) expense factors associated with the acquisition and underwriting of a contract; 3) expense factors associated with the ongoing administration of the contract; 4) investment management fees and/or other factors impacting net investment performance, both pre and post retirement; 5) cost of capital; 6) target returns on the contracts; and, 7) expected investment returns, both pre and post retirement, 8) actual historical claims experience, 9) actual mortality experience, 10) extreme, exogenous events, actual and possible, that may impact claim or investment returns, e.g., pandemics.

The insurance company specific factors may be the same or different for the alternatives. If the varieties of contract being compared are highly similar, differences in the insurance company specific factors may be the primary driver of differences in the comparison outputs. If the insurance company specific factors are (essentially) the same and the varieties of contracts differ, differences in contract variety may be the primary driver of differences in the comparison outputs. If both insurance company specific factors and the form of the contracts differ, the differences in the comparison outputs may be driven by differences in both.

Given the Personal Data Input, the Economic Scenario Input, and the Comparison Inputs—including the contract variety of the first alternative; the contract variety of the second alternative; other underwriting variables (including company specific factors); and the timing and duration of occurrence(s) of a qualifying event—the system may determine a specification for each alternative contract and expected outputs for each alternative and graph the output comparisons in the Graph of Determined Output display of the GUI. Alternatively, the comparison contracts entered into the system may have been previously underwritten and specified, in which case the system will determine expected outputs for each alternative and graph the output comparisons in the Graph of Determined Output display of the GUI.

Comparisons may be determined and displayed for a variety of comparisons, including but not limited to: 1) comparisons between no insurance contract and one or more varieties of contingent deferred income annuity contracts protecting against losses due to pre-retirement risks; 2) comparisons between two or more varieties of contingent deferred income annuity contracts protecting against losses due to pre-retirement risks; 3) comparisons of determined outputs of the same variety of contingent deferred annuity contract protecting against losses due to pre-retirement risks over two or more economic scenarios; and, 4) comparisons of determined outputs of the same variety of insurance contract protecting against losses due to pre-retirement risks over differing insurance company specific factors impacting the underwriting, specification and/or performance of the contracts.

The varieties of contingent deferred income annuity contracts protecting against losses due to pre-retirement risks include, but are not limited to: 1) fixed contracts in which the insurance company guarantees a fixed return in the event of a qualifying event, both during the pre-retirement accumulation period and during the annuity pay-out period; 2) fixed contracts in which the insurance company guarantees an index-adjusted return (e.g., a real, net of inflation return determined using the Consumer Price Index all Urban consumers) both during the pre-retirement period and during the annuity pay-out period; 3) variable contracts in which investment performance is linked to market interest rates and/or market performance (e.g., the Barclay's Agg index, the Barclay's MBS fixed-rate index, the S&P 500, etc.) both during the pre-retirement accumulation period and during the annuity pay-out period; 4) variable contracts including a performance guarantee—e.g., a guaranteed floor rate of return, a guaranteed floor annuity payment (as a function of the duration of an occurrence of a qualifying event), etc.; 5 years) fixed/variable contracts with a fixed rate of return during the pre-retirement accumulation period and a variable return during the annuity pay-out period; 6) variable/fixed contracts with a variable rate of return during the pre-retirement accumulation period and a fixed return during the annuity pay-out period; and 7) specified periodic (e.g., annual, monthly, quarterly) benefit (i.e., DIA) payments derived from a pre-defined method for determining the retirement income delta caused by the occurrence of the qualifying event (e.g., disabled for 5 years results in $1,000 per month for life). It should be noted that for this last approach (#7) alone, there are nearly infinite permutations that may be offered requiring complex risk evaluation, especially given the extended period in question—in some cases, decades before a payment commences and then, subsequently, decades of possible payments, possibly with inflation or cost of living increases based on actual or hypothetical inflation. Such analysis cannot be completed in a reasonable time by a human operator, nor are conventional systems capable of, or configured to implement, such calculations absent the embodiments disclosed herein.

In an embodiment, some transactions and data disclosed herein may be implemented on a computerized distributed ledger system. Several of the points underscoring the exceptional utility, if not need, of a GUI interface, relate to the challenges of cost effectively distributing coverage to millions of unrelated individuals. The information each individual must submit through the GUI so that one or more insurers can provide competitive cost quotes is intrinsically confidential, highly sensitive and personal. Data breaches by large corporations, governmental agencies and regulators are unfortunately becoming more commonplace despite advances in data security patches, programs, protocols and practices. Incremental improvements and patches to legacy computer systems is presently inadequate to the task of reliably securing the personal information required with a GUI enabled system achieving the steps previously enumerated. Moreover, providing insurers, applicants and buyers necessary disclosures and transparency while simultaneously protecting sensitive information is simply beyond the capability of legacy computer systems. For example, for insurers to continue to provide competitive quotations, they must know they are competing on a fair and equitable basis. Any suspicion that other insurers enjoy an unfair advantage will result in them withdrawing from the market, ultimately endangering market viability. Separately, if a financial advisor, especially one acting in a fiduciary capacity, uses our GUI system to advise a client regarding the selection of a product or insurer and the objectivity of the recommendation is later challenged, they will need an unassailable, unalterable record supporting their recommendation(s). Also, the applicant and insureds have needs at seeming odds between privacy and transparency. An applicant may want her identity, neighborhood, and other personally identifiable information withheld from the risk profile information made available to a plurality of insurers so that only the selected insurer knows her actual, full identity (i.e., after she makes her final choice). Once coverage is in force the claims paying and service track records of each insurer can only be objectively and meaningfully tracked in ways that help all market participants if individually identifying information (names, social security numbers, etc.) can reliably be omitted from information shared with regulators and other interested parties. A computerized, distributed ledger-based system may be preferred over conventional data storage techniques for fulfilling the needs of all the parties given their divergent, complex, demanding and far reaching needs. For example, a distributed ledger system may provide multiple benefits specific to the embodiments disclosed herein, which conventional data storage systems may be unable or ill-suited to provide. For example, embodiments disclosed herein may obtain personal information for individuals from a variety of sources and/or at different points in time. By storing such data in a distributed ledger, consumers of the data may be able to easily put together a complete and accurate profile by tracing updates to the personal information through the distributed ledger. Similarly, this allows multiple consumers of the personal data to verify that each of them has the correct current data without requiring each consumer to verify the data with the individual(s) to which it applies. As a specific example, where multiple insurance providers wish to provide a quote for a particular policy as disclosed herein, each provider may obtain the insured's personal information from the distributed ledger, following rules and policies that apply to the ledger, to obtain those portions of the personal information that are needed for each insurer's quote (as allowed, for example, by the system and/or the individual that provided the information). In conventional systems, each insurer would necessarily have to obtain the same personal information from the insured person, leading to unnecessary duplication and the possibility of error. Furthermore, many distributed ledger systems provide built-in encryption, privacy controls, and/or permission systems that may allow for individuals to more securely and reliably specify the entities that can access their personal information, and under what circumstances and have unalterable records affirming their privacy rights have either been honored or breached, and if breached, by whom and to what extent. More generally, individuals may have greater control over their personal information than is possible in conventional data storage systems.

Another benefit of using a distributed ledger is that, in some embodiments, consumers, advisors, and the like may be able to evaluate insurers and other entities based on their prior performance if transactions related to those entities are stored in a distributed ledger. For example, different insurance providers may behave differently when responding to claims submitted by insured parties. Some insurers may process such claims on a set schedule and may pay an average percentage of such claims, while others may dispute or challenge a higher percentage of claims submitted by insured parties. Furthermore, the behavior of individual insurers may change over time. By recording such transactions in a distributed ledger that can be accessed by individuals, advisors, and other parties, consumers may be able to make more informed and accurate decisions with regard to which policies, insurers, and combinations thereof are likely to meet their needs. For example, an advisor or insured party may consider the past behavior of each insurer that provides a quote before selecting a particular insurer and/or policy. An impartial repository of insurer behavior will tend to attract participation from insurers that are confident they can compete on the merits of their services and claims practices and repel those tending to treat customers unfairly.

The embodiments disclosed herein may be carried out by at least one digital computer system performing the digital signal processing for generating output useful in underwriting, specifying, supporting, servicing and/or administrating, and comparing contingent deferred income annuity contracts for protecting retirement income from losses due to various pre-retirement risks faced by participants in retirement plans and owners of individual retirement plans. The contracts may be held either within or outside of the retirement plans.

The underwriting and specification of a contract may include a requirement that the determined present value of the expected premium payments is greater than the determined present value of the expected deferred income annuity payments.

The expected premium payments may be a function of the probabilities of the occurrence of one or more events that would cause suspension or loss of contributions, with the probabilities being determined after accessing data regarding the probabilities. The present value of the expected premium payments may be a function of expected returns prior to the (possible) commencement deferred income annuity payments, with the expected returns being determined after accessing data regarding returns.

Similarly, the expected deferred income annuity payments may be a function of the probabilities of the occurrence of one or more events that would cause loss, reduction or suspension of contributions, with the probabilities being determined after accessing data regarding the probabilities. The present value of the expected deferred income annuity payments may be a function of expected returns prior to and subsequent to the (possible) commencement of the deferred income annuity payments, with the expected returns being determined after accessing data regarding returns.

In some embodiments the nominal dollar amount of the deferred income annuity payments may be linked to an index—e.g., the nominal dollar amount may be adjusted using a price index in order to protect against inflation or the nominal dollar amount may be a function of an investment index, thereby varying the nominal dollar amount according to the performance of the investment index. In variations of the embodiments, the nominal dollar amount may be subject to a floor amount.

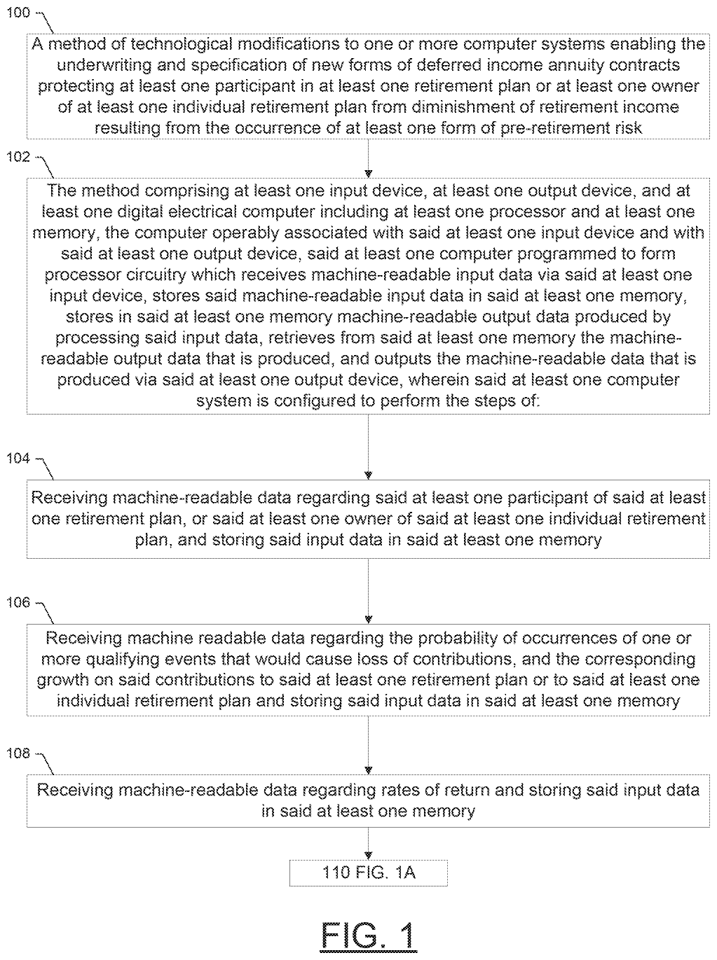

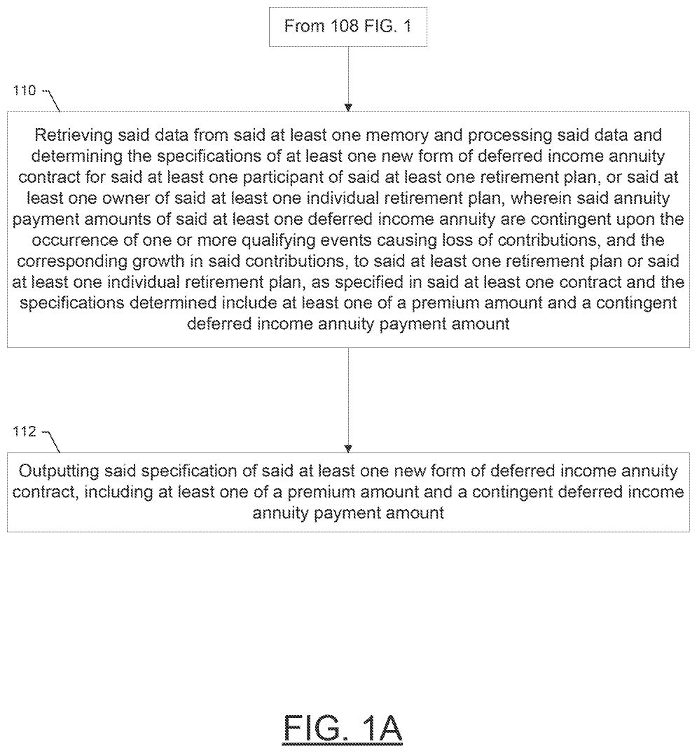

As an illustrative embodiment, begin by considering FIG. 1, which, together with FIG. 1A, shows, in flow chart form, a computerized method of automatically enabling the underwriting and specification of contingent deferred income annuity contracts protecting at least one participant in at least one retirement plan or at least one owner of at least one individual retirement plan from diminishment of retirement income resulting from the occurrence of at least one form of pre-retirement risk 100. As previously disclosed, the methods shown and described with respect to FIGS. 1-1A, and the other methods disclosed herein, may be performed in conjunction with one or more user interfaces that provide understandable representations of the contracts and their relationship to other accounts, activities, and other parameters. Similarly, the methods described here and throughout this disclosure may be implemented on a distributed ledger to provide for privacy-controlled storage and manipulation of data associated with the contracts and other accounts.

Contingent deferred income annuity contracts protect against diminishment of retirement income due to the occurrence of one or more qualifying events that may result in loss (total or partial) of retirement contributions to a retirement plan over the duration of the occurrence. Possible qualifying events include, but are not limited to: 1) a disability event; and, 2) an employment related event (e.g., unemployment, technological change, etc.) that suspends, reduces or eliminates the ability to make contributions to a retirement plan.

The amounts of the deferred income annuity payments may be a function of, among other factors, the length of term of a qualifying event and/or the timing of the occurrence of a qualifying event relative to the expected retirement time. A contract may include a cessation of scheduled premiums in the event of the occurrence of a qualifying event. The expected premium stream may be a function of a number of factors including, but not limited to: 1) a specified premium amount; 2) a specified time period until retirement; 3) probabilities of the occurrence of one or more qualifying events; 4) probabilities of the timing of occurrences of one or more qualifying events; 5) probabilities of the duration of one or more qualifying events, 6) expectations regarding the number of contracts purchased; 7) expectations regarding behavioral patterns of the insured population; 8) longevity risk; 9) lapse risk; 10) mortality experience; 11) investment experience 12) expectations of investment performance, morbidity experience and other factors.

The method may be performed via a system that includes at least one input device, at least one output device, and at least one digital electrical computer including at least one processor and at least one memory, the computer operably associated with the input device and the output device and configured and programmed to form processor circuitry which receives machine-readable input data via the input device, stores machine-readable input data in the memory, stores machine-readable output data produced by processing the input data, retrieves from the memory the machine-readable output data that is produced, and outputs the machine-readable data that is produced via the output device. The computer system may be configured to perform step 102 enabling the underwriting and specification of at least one contingent deferred income annuity contract protecting at least one participant in at least one retirement plan or at least one owner of at least one individual retirement plan from diminishment of retirement income resulting from the occurrence of at least one form of pre-retirement risk.

Devices, including but not limited to servers, cloud computing services, personal computers, tablets and smart phones, may be networked together using the internet, local area networks, wide area networks, private networks, virtual private networks and/or other networking connections to perform some or all of the methods disclosed herein. A network may or may not include the use of a distributed ledger.

The method may include receiving machine-readable data regarding the participant of the retirement plan, or the owner of the individual retirement plan, and storing input data in the memory 104. Data received may include, but is not limited to age, gender, income (current and historical), occupation, contribution history, education, health, location, planned retirement date, hobbies and activities. Data on contribution history may include or not include data on roll-over contribution amounts. If data on roll-over contribution amounts is included, data on contribution amounts may be broken down into non-roll-over and roll-over components.

The step of receiving may further include receiving machine readable data regarding the probability of occurrences of one or more qualifying events that would cause loss, reduction or suspension of contributions, and the corresponding growth on said contributions to the retirement plan or to the individual retirement plan and storing the input data in the memory 106. Data regarding the probability of occurrences of one or more qualifying events may include probabilities of timing and duration, including, but not limited to, cumulative probabilities over time of occurrences and/or durations. Data regarding growth of contributions may include, but is not limited to, historical income growth for various occupations, projected income growth under various economic scenarios, and probabilities regarding said scenarios.

The step of receiving may further include receiving machine-readable data regarding rates of return and storing said input data in the memory at 108. Rates of return may include, but are not limited to, risk-free interest rates for various maturities of instruments, interest rates for securities of various credit qualities and/or maturities, inflation rates and price level data, real (net of inflation) interest rates, rates of return on various investment indices (including the indices themselves), projected rates of return for various investments given various economic scenarios, and probabilities of said economic scenarios.

The step of receiving may further include receiving machine readable data regarding a specified variation of contingent deferred income annuity contract. The varieties of contingent deferred income annuity contracts protecting against diminishment of retirement income due to the occurrence of at least one pre-retirement risk include, but are not limited to: 1) fixed contracts in which the insurance company guarantees a fixed return in the event of a qualifying event, both during the pre-retirement accumulation period and during the annuity pay-out period; 2) fixed contracts in which the insurance company guarantees an index-adjusted return (e.g., a real, net of inflation return determined using the Consumer Price Index all Urban consumers) both during the pre-retirement period and during the annuity pay-out period; 3) variable contracts in which investment performance is linked to market interest rates and/or market performance (e.g., the Barclay's Agg index, the Barclay's MBS fixed-rate index, the S&P 500 index) both during the pre-retirement accumulation period and during the annuity pay-out period; 4) variable contracts including a performance guarantee—e.g., a guaranteed floor rate of return, a guaranteed floor annuity payment (as a function of the duration of an occurrence of a qualifying event), etc.; 5) fixed/variable contracts with a fixed rate of return during the pre-retirement accumulation period and a variable return during the annuity pay-out period; 6) variable/fixed contracts with a variable rate of return during the pre-retirement accumulation period and a fixed return during the annuity pay-out period; and 7) specified periodic (e.g., annual, monthly, quarterly) benefit (i.e., DIA) payments derived from a pre-defined method for determining the retirement income delta caused by the occurrence of the qualifying event (e.g., disabled for 5 years results in $1,000 per month for life).

The step of receiving may still further include receiving other underwriting machine readable data, including insurance company specific factors that may impact underwriting and, therefore, the determined premium amount and/or the determined contingent deferred income annuity payment amount. Examples of insurance company specific factors that may impact underwriting may include, but are not limited to, insurance company cost factors with regard to contract acquisition and/or administration servicing, insurance company cost of capital, insurance company target returns, insurance company assessment of pre-retirement returns, insurance company assessment of pos-retirement returns, and insurance company assessment of contract risks.

FIG. 1A continues the steps of the method from FIG. 1, beginning with retrieving data from the memory, processing the data, and determining the specifications of at least one contingent deferred income annuity contract for the participant of the retirement plan, or the owner of the individual retirement plan. The annuity payment amounts of the contingent deferred income annuity typically are contingent upon the occurrence of one or more qualifying events causing loss of contributions, and the corresponding growth in said contributions, to the retirement plan or the individual retirement plan, as specified in the contract. The specifications determined may include at least one of a premium amount and a contingent deferred income annuity payment amount 110.

The step of retrieving and determining may include retrieving data regarding the probability of occurrences of one or more events that could cause loss of contributions and using the retrieved data to determine at least one of a set of expected premium amounts and a set of expected contingent deferred income annuity payments. The retrieved probability of occurrences data may include probabilities of timing and duration, including, but not limited to, cumulative probabilities over time of occurrences and/or durations.

The step of retrieving and determining may further include retrieving data on rates of return and using the data in determining at least one set of expected returns. The determining of expected returns may include expected returns prior to the commencement of the contingent deferred income annuity payments and/or subsequent to the commencement of the contingent deferred income annuity payments.

The step of retrieving and determining may further include implementing a requirement that the determined present value of the expected set of premium payments is greater than the determined present value of the determined set of expected contingent income annuity payments.

The step of retrieving and determining may further include retrieving insurance company data and implementing a requirement that the determined present value of the expected premium payments, net of insurance company acquisition and administration costs, is equal to or greater than the determined present value of the determined set of expected contingent income annuity payments and/or a requirement that the determined set of expected premium payments will generate a net return to the insurance company equal to or greater than the target return.

The step of retrieving and determining may yet further include retrieving data on contributions that were actually and previously made to the retirement plan and using the data in determining at least one of a premium amount and a contingent deferred income annuity payment amount wherein the retrieving of data on contributions may or may not exclude roll-over contribution amounts.

The step of retrieving and determining may still further include retrieving data regarding the variety of the contingent deferred income annuity contract and using the data in determining at least one of a premium amount and a contingent deferred income annuity payment amount. In the event that the contract is a fixed (nominal dollar) contract, a determined contingent income annuity payment may be a function of the time and duration of an occurrence of a qualifying event, where the function determines a fixed nominal dollar payment amount. In the event that the contract is a fixed real (nominal dollar amounts adjusted by a price index) contract, a determined contingent income annuity payment may be a function of the time and duration of an occurrence of a qualifying event, in which the function determines a fixed real payment amount. In the event that the contract is a variable (contract investment returns defined to be a function of an investment index) contract, a determined contingent income annuity payment may be a function of the time and duration of an occurrence of a qualifying event, wherein the function determines a payment amount as a function of the performance of the investment index. In the event that the contract is a variable (contract investment returns defined to be a function of an investment index) contract with a performance guarantee clause, a determined contingent income annuity payment may be a function of the time and duration of an occurrence of a qualifying event, where the function determines a payment amount as a function of the performance of the investment index subject to a minimum performance guarantee. An example of a possible investment guarantee clause would be a guarantee of a minimum floor nominal dollar payment amount, wherein the dollar amount of the floor is a function of the time and duration of the occurrence of a qualifying event.

The step of outputting may include outputting a specification of at least one contingent deferred income annuity contract, including at least one of a premium amount and a contingent deferred income annuity payment amount at 112.

The output data may further include, but is not limited to, some or all of: 1) a set of data regarding the participant in the retirement plan or owner of the individual retirement plan; 2) a set of data regarding probabilities of occurrences of a qualifying event; 3) a set data regarding rates of return and/or projected performance of an investment index; 4) a set of data regarding insurance company specific factors; 5) a set of data regarding the chosen variation of a contingent deferred income annuity contract; and, 6) a set of data regarding one or more economic scenarios.

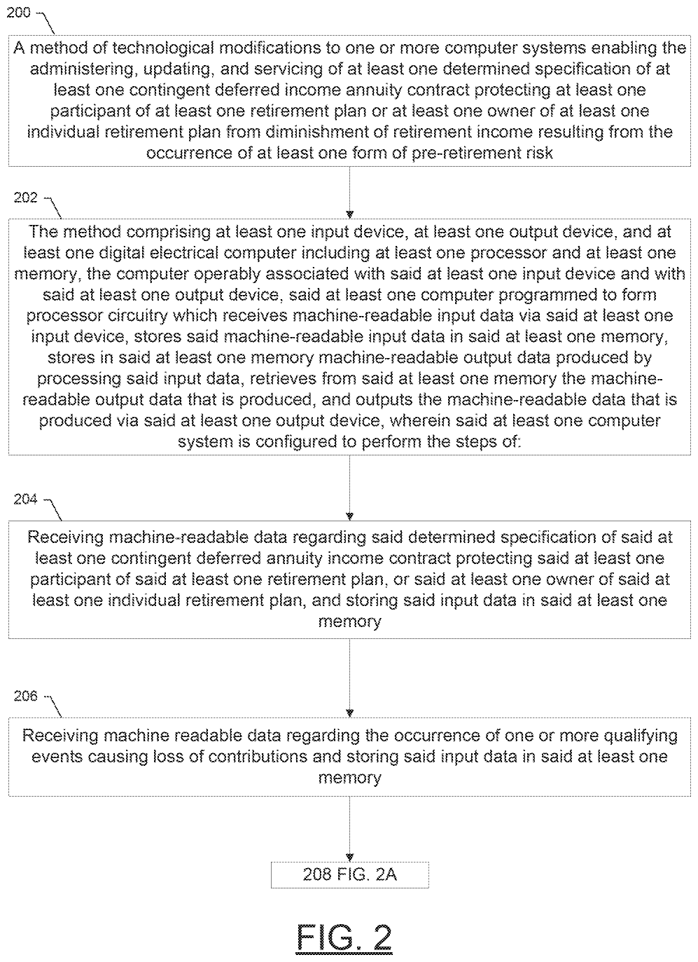

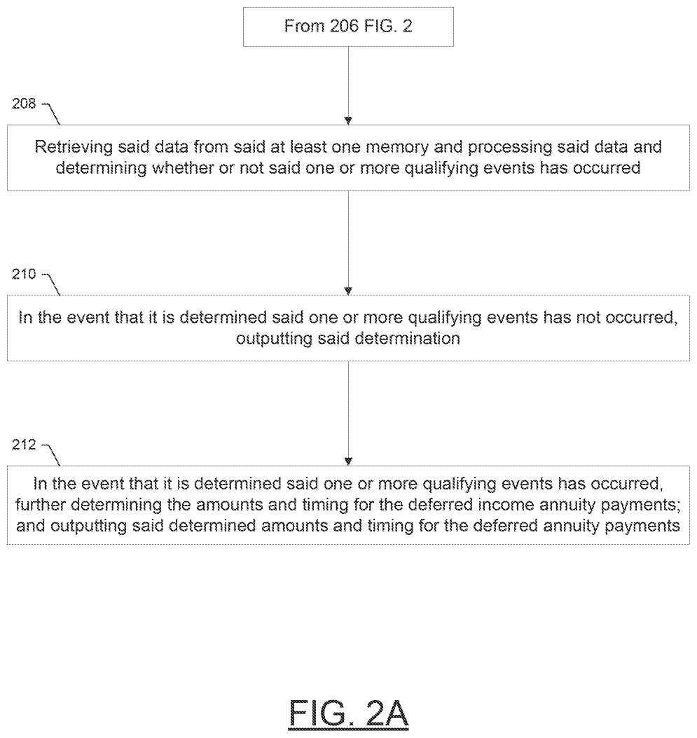

In another aspect of an embodiment, FIG. 2, together with FIG. 2A, show, in flow chart form, a method of administering, updating, and servicing of at least one determined specification of at least one contingent deferred income annuity contract protecting at least one participant of at least one retirement plan or at least one owner of at least one individual retirement plan from diminishment of retirement income resulting from the occurrence of at least one form of pre-retirement risks 200.

Contingent deferred income annuity contracts protect against diminishment of retirement income due to the occurrence of one or more qualifying events that may result in loss (total or partial) of retirement contributions to a retirement plan over the duration of the occurrence. Possible qualifying events include, but are not limited to: 1) a disability event; and, 2) an employment related event (e.g., unemployment, technological change, pandemics, etc.) that suspends, reduces or eliminates the ability to make contributions to a retirement plan.

The method may be performed via a system that includes at least one input device, at least one output device, and at least one digital electrical computer including at least one processor and at least one memory, the computer operably associated with the input device and the output device and configured and programmed to form processor circuitry which receives machine-readable input data via the input device, stores machine-readable input data in the memory, stores machine-readable output data produced by processing the input data, retrieves from the memory the machine-readable output data that is produced, and outputs the machine-readable data that is produced via the output device. The computer system may be configured to perform step 202 and other steps and processes disclosed herein, thereby enabling the administering, updating, and servicing of at least one contingent deferred income annuity contract protecting at least one participant in at least one retirement plan or at least one owner of at least one individual retirement plan from diminishment of retirement income resulting from the occurrence one or more pre-retirement risks.

Devices, including but not limited to, servers, cloud computing services, personal computers, tablets and smart phones, may be networked together using the internet, local area networks, wide area networks, private networks, virtual private networks and/or other networking connections to implement the embodiments disclosed herein. A network may or may not include the use of a distributed ledger.

The process may include the step of receiving machine-readable data regarding a determined specification of at least one contingent deferred annuity income contract protecting at least one participant of said at least one retirement plan, or at least one owner of said at least one individual retirement plan, and storing the input data in a memory 204.

The step of receiving may further include receiving updated machine-readable data regarding the participant of the retirement plan, or the owner of the individual retirement plan, and storing the updated data in the computer-readable memory.

The step of receiving may include receiving updated machine readable data regarding the probability of occurrences of one or more qualifying events that would cause loss, reduction or suspension of contributions, and the corresponding growth on said contributions to the retirement plan or to the individual retirement plan and storing said updated data in the memory.

The step of receiving may include receiving updated machine-readable data regarding rates of return and storing the updated data in the computer-readable memory. Rates of return may include, but are not limited to, risk-free interest rates for various maturities of instruments, interest rates for securities of various credit qualities and/or maturities, inflation rates and price level data, real (net of inflation) interest rates, rates of return on various investment indices (including the indices themselves), projected rates of return for various investments given various economic scenarios, and probabilities of said economic scenarios.

The step of receiving may yet further include receiving machine readable data regarding the occurrence of one or more qualifying events causing loss of contributions and storing said input data in said at least one memory 206.

FIG. 2A continues the steps of the method from FIG. 2, beginning with retrieving data from a memory, processing the data, and determining whether or not said one or more qualifying events has occurred 208.

In the event that it is determined said one or more qualifying events has not occurred, a determination to that effect may be output at 210. In the event that it is determined said one or more qualifying events has occurred, the process may further determine the amounts and timing for deferred income annuity payments, and output such determined amounts and appropriate timing for the deferred annuity payments 212.

The step of outputting may further include outputting, in whole or in part, updated data regarding the participant or owner, probabilities, and/or rates of return.

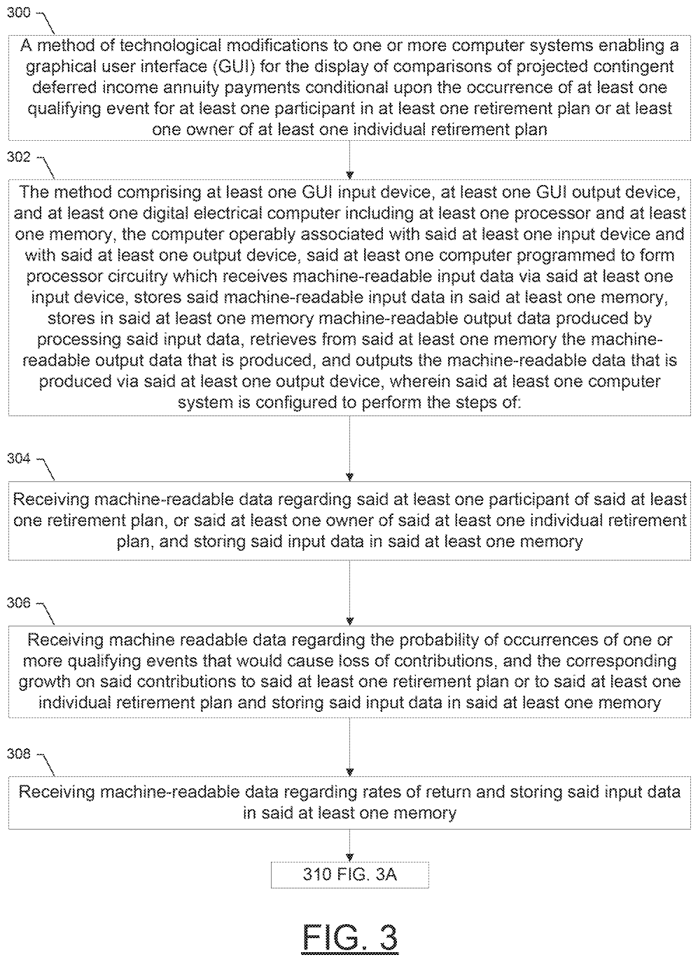

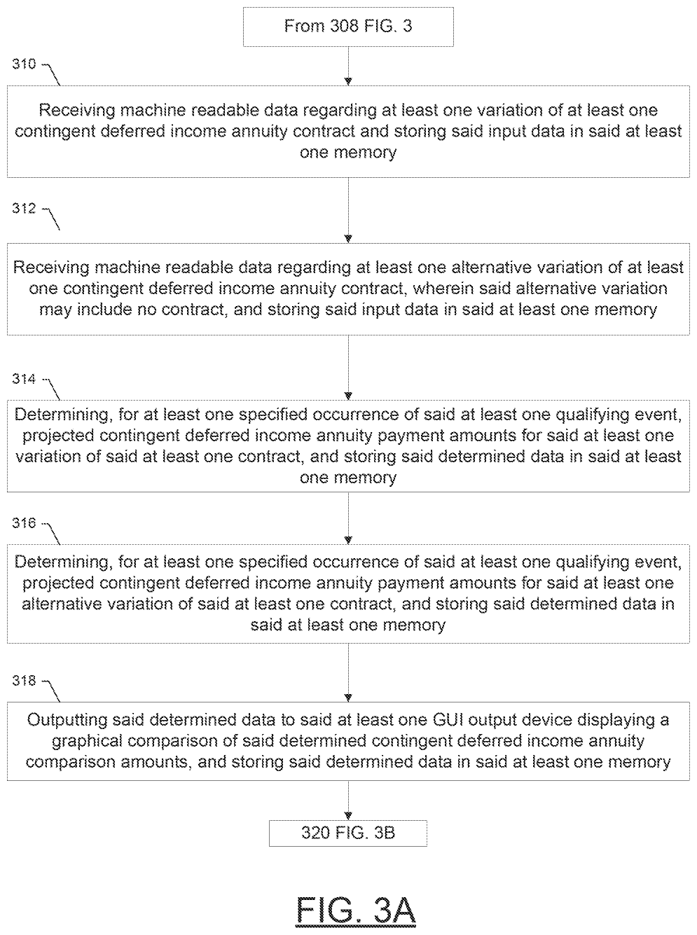

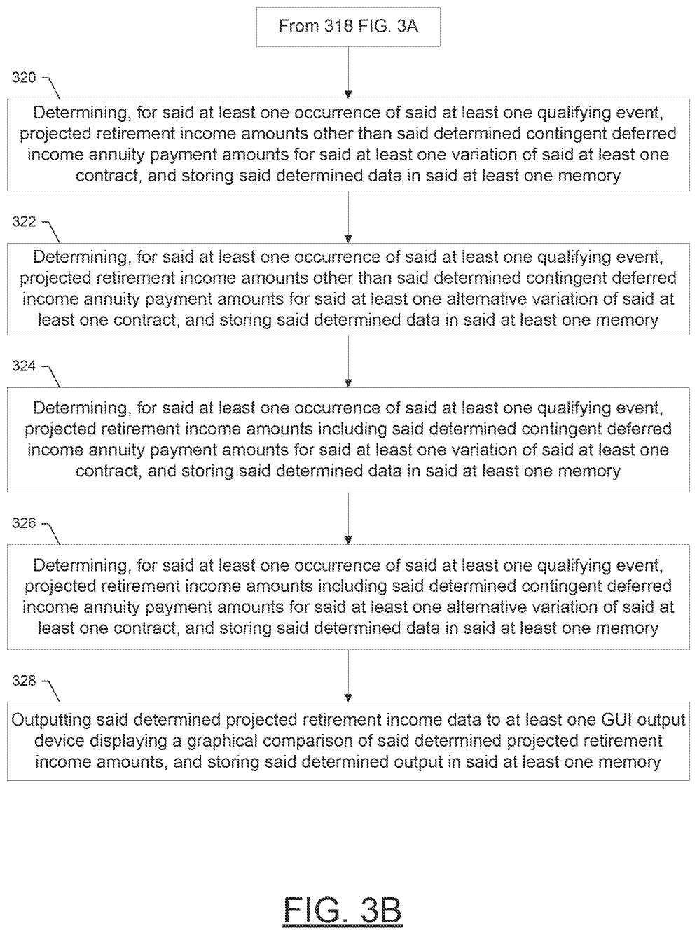

In an embodiment, FIG. 3, together with FIGS. 3A and 3B, show, in flow chart form, a method providing a graphical user interface (GUI) for the display of comparisons of projected contingent deferred income annuity payments conditional upon the occurrence of at least one qualifying event for at least one participant in at least one retirement plan or at least one owner of at least one individual retirement plan 300.

The method may include a computer device and/or system as previously disclosed, which may be configured and programmed to perform the process shown in FIG. 3. At 302 a GUI may be used to display comparisons of projected contingent deferred income annuity payments conditional upon the occurrence of at least one qualifying event for at least one participant in at least one retirement plan or at least one owner of at least one individual retirement plan.

The process may include a step of receiving machine-readable data regarding at least one participant of at least one retirement plan, or at least one owner of at least one individual retirement plan, and storing said input data in a computer-readable memory 304. Data received may include, but is not limited to age, gender, income (current and historical), occupation, contribution history, education, health, location, planned retirement date, hobbies and activities. Data on contribution history may include or not include data on roll-over contribution amounts. If data on roll-over contribution amounts is included, data on contribution amounts may be broken down into non-roll-over and roll-over components.

The step of receiving may further include receiving machine readable data regarding the probability of occurrences of one or more qualifying events that would cause loss, reduction or suspension of contributions, and the corresponding growth on contributions to the retirement plan or to the individual retirement plan and storing the input data in a computer-readable memory at 306. Data regarding the probability of occurrences of one or more qualifying events may include probabilities of timing and duration, including, but not limited to, cumulative probabilities over time of occurrences and/or durations. Data regarding growth of contributions may include, but is not limited to, historical income growth for various occupations, projected income growth under various economic scenarios, and probabilities regarding said scenarios.

The step of receiving may include receiving machine-readable data regarding rates of return and storing the input data in a computer-readable memory at 308. Rates of return may include, but are not limited to, risk-free interest rates for various maturities of instruments, interest rates for securities of various credit qualities and/or maturities, inflation rates and price level data, real (net of inflation) interest rates, rates of return on various investment indices (including the indices themselves), projected rates of return for various investments given various economic scenarios, and probabilities of said economic scenarios. In addition to financial data, data received may include economic scenario data, including historical and projected economic and financial data.

The step of receiving may include receiving machine readable data for insurance company specific data that may impact underwriting and, therefore, the determined premium amount and/or the determined deferred income annuity payment amount. Examples of insurance company specific data that may impact underwriting may include, but is not limited to, insurance company cost factors with regard to contract acquisition and/or administration servicing, insurance company cost of capital, insurance company target returns, insurance company assessment of pre-retirement returns, insurance company assessment of pos-retirement returns, and insurance company assessment of contract risks. In the event the comparison involves a comparison between different insurance companies and/or a comparison illustrating the impact of insurance company specific factors on determined contingent deferred income annuity amounts, the receiving may include receiving more than one set of insurance company specific factors.

FIG. 3A continues the steps of the method from FIG. 3, beginning with receiving machine readable data regarding at least one variation of a contingent deferred income annuity contract and storing the data in a computer-readable memory at 310, and storing machine readable data regarding at least one alternative variation of at least one contingent deferred income annuity contract, which may include no contract, and storing the input data in a computer-readable memory at 312.

The varieties of contingent deferred income annuity contracts protecting against losses due to pre-retirement risks include, but are not limited to: 1) fixed contracts in which the insurance company guarantees a fixed return in the event of a qualifying event, both during the pre-retirement accumulation period and during the annuity pay-out period; 2) fixed contracts in which the insurance company guarantees an index-adjusted return (e.g., a real, net of inflation return determined using the Consumer Price Index all Urban consumers) both during the pre-retirement period and during the annuity pay-out period; 3) variable contracts in which investment performance is linked to market interest rates and/or market performance (e.g., the Barclay's Agg index, the Barclay's MBS fixed-rate index, the S&P 500 index, etc.) both during the pre-retirement accumulation period and during the annuity pay-out period; 4) variable contracts including a performance guarantee—e.g., a guaranteed floor rate of return, a guaranteed floor annuity payment (as a function of the duration of an occurrence of a qualifying event), etc.; 5) fixed/variable contracts with a fixed rate of return during the pre-retirement accumulation period and a variable return during the annuity pay-out period; 6) variable/fixed contracts with a variable rate of return during the pre-retirement accumulation period and a fixed return during the annuity pay-out period; and 7) specified periodic (e.g., annual, monthly, quarterly) benefit (i.e., DIA) payments derived from a pre-defined method for determining the retirement income delta caused by the occurrence of the qualifying event (e.g., disabled for 5 years results in $1,000 per month for life).

The process may include determining, for at least one specified occurrence of a qualifying event, projected contingent deferred income annuity payment amounts for at least one variation of said at least one contract, and storing the determined data in a computer-readable memory 314 and determining, for at least one specified occurrence of said at least one qualifying event, projected contingent deferred income annuity payment amounts for at least one alternative variation of at least one contract, and storing the determined data in a computer-readable memory at 316.

The process may include outputting the determined data to a GUI output device displaying a graphical comparison of the determined contingent deferred income annuity comparison amounts, and storing the determined data in a computer-readable memory 318.

FIG. 3B continues the method from FIG. 3A, beginning with determining, for said at least one occurrence of said at least one qualifying event, projected retirement income amounts other than said determined contingent deferred income annuity payment amounts for said at least one variation of said at least one contract, and storing said determined data in a memory 320 and determining, for at least one occurrence of at least one qualifying event, projected retirement income amounts other than the determined contingent deferred income annuity payment amounts for at least one alternative variation of at least one contract, and storing the determined data in a computer-readable memory 322.

The step of determining and storing may include determining, for at least one occurrence of at least one qualifying event, projected retirement income amounts including a determined contingent deferred income annuity payment amounts for at least one variation of at least one contract, and storing the determined data in a computer-readable memory at 324; and determining, for at least one occurrence of at least one qualifying event, projected retirement income amounts including determined contingent deferred income annuity payment amounts for at least one alternative variation of at least one contract, and storing the determined data in a computer-readable memory 326.

The step of outputting determined projected retirement income data to at least one GUI output device displaying a graphical comparison of the determined projected retirement income amounts, and storing the determined output in a computer-readable memory 328. The comparison graph may break down the retirement income amounts into the components of the determined contingent deferred income annuity amounts and the determined amount of retirement income other than the determined contingent deferred income annuity amounts.

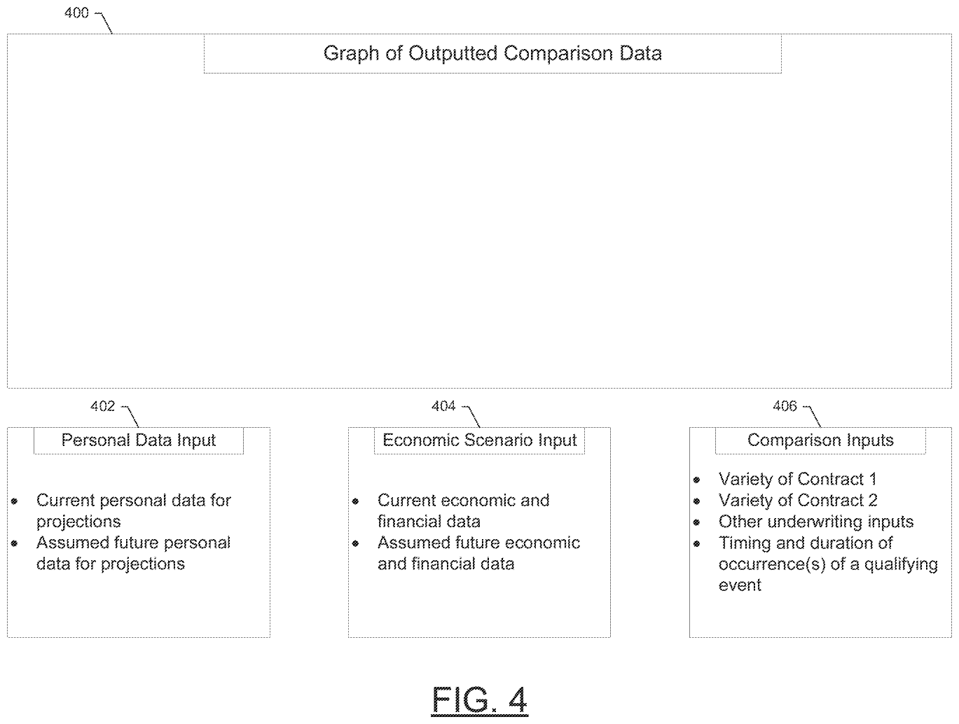

FIG. 4 illustrates an example GUI with both input and output capabilities. Although the input and output capabilities are combined in one device in this preferred embodiment, they also may be separated into multiple devices.

The embodiment illustrated in FIG. 4 includes a graphical comparison of determined retirement income amounts 400; an input/output display of personal data 402; an input/output display of economic scenario data 404; and an input/output display of data specifying the alternatives being compared 406.

The input/output displays may show key data inputs used in determining the comparison output graph. In the preferred embodiment, clicking on a key data input displays the input data in detail and enables the user to change input data and this new data will then be used in determining new output data that will be displayed using the comparison output graph.

These graphical comparisons may enable the user to see the cost/benefit tradeoffs inherent in a wide variety of potentially available coverages, relative both to other potentially available coverages and to the choice of no coverage For example, these interfaces may allow a user to clearly and immediately see and understand comparisons of 1) how much additional savings accrues in the absence of paying a premium if the contingency never occurs; versus 2) paying the premium and never experiencing a claim; versus 3) not paying the premium but experiencing the contingent event and thereby losing out on the benefit; versus 4) paying the premium experiencing the contingent event and receiving the insured benefit upon retirement). Furthermore, the visualizations may be provided over a wide variety of potential future scenarios defined by, for example, 1) current and projected personal data; 2) current and projected economic and financial data; and, 3) various possible timings and durations of qualifying events (including no occurrence of a qualifying event). In the absence of this ability to generate graphical comparisons of projected future retirement incomes over a wide variety of potential future scenarios, it would be difficult or impossible for a typical user to have an accurate sense of the cost/benefit tradeoff inherent in any available coverage option, or even the basic differences in scope and magnitude of two competing options. In the absence of an accurate sense of the cost/benefit tradeoff of an available coverage, the user may have no sound basis for choosing one available coverage over another—or simply no coverage at all.

Notably, the calculations and outputs disclosed herein require computational resources far in excess of what could be performed by human users, regardless of the number of individuals used to perform the calculations. For example, embodiments disclosed herein produces comparisons of the results of at least two alternative options regarding deferred annuity protection, which may be displayed via a graphical user interface as disclosed herein. The output device allows the user to determine the input factors used to generate the comparative output and, at the option of the user, to change one or more impact factors with the system generating and outputting a revised comparison in real time.

Generating an output for an option in the comparison requires determining, for each month prior to retirement and each month subsequent to retirement, the specific values for a large number of factors each month—e.g., the state of the economy, the state of interest rates, the state of various market indices, the income of the user, whether or not a specified event has occurred, etc.—which themselves may be multi-variate and require re-calculation in a relatively short time to retain a useful degree of accuracy. One or more of these factors may be determined using a probability distribution. The determined factors then may be used, for each month, to calculate intermediate values which will be combined into a calculation of the output for the option. Generally the calculations for each month must be performed sequentially as the intermediate output for each month is a function of the results from prior months.

In preferred embodiments, output comparisons may involve the use of Monte Carlo or similar simulations, which may require requiring rerunning the comparison tens of thousands of times with each run involving the generation, each month, of one or more random numbers that are then applied to specified probability distributions in order to determine the specific values for one or more of the monthly input factors—e.g., the state of the economy, the state of interest rates, the state of various market indices, the income of the user, whether or not a specified event has occurred, etc., as previously disclosed. Upon completion of Monte Carlo runs, the system may organize the outputs of the Monte Carlo simulation for each option in order of size (e.g., smallest to largest or largest to smallest), determine specified percentile amounts (e.g., 5th percentile, 20th percentile, 50th percentile, 70th percentile, 95th percentile, etc.) and graphically display the output comparison on the output device. Such calculations cannot reasonably be performed by individual users and, in fact, require a custom computerized system as disclosed herein. Notably, this is also the case where techniques other than Monte Carlo simulations are used, since a similar approach using the same scale of data and calculations should be used to arrive at accurate and usable projections.

Although embodiments disclosed herein have been illustrated using various specific examples, the scope of the invention should be determined by the appended claims and their legal equivalents, rather than by individual illustrative embodiments and other examples described above.

1. A method comprising:
receiving machine-readable data regarding at least one participant in at least one retirement plan or at least one owner of at least one individual retirement plan, and storing said input data in a computer-readable memory;
receiving machine-readable data regarding the probability of occurrences of one or more qualifying events that would cause loss, reduction or suspension of contributions and a corresponding growth on said contributions to the retirement plan or the individual retirement plan and storing the input data in the computer-readable memory;
receiving machine-readable data regarding rates of return;
based upon the data regarding the probability of occurrences of one or more qualifying events and the rates of return, determining specifications of at least one contingent deferred income annuity contract for the participant in the at least one retirement plan or the owner of the individual retirement plan, wherein the annuity payment amounts of the deferred income annuity are contingent upon the occurrence of the one or more qualifying events as specified in the at least one contract and the specifications include at least one of a premium amount and a contingent deferred income annuity payment amount; and,
outputting the specifications of the contract, including at least one of a premium amount and a contingent deferred income annuity payment amount.

2. The method of claim 1, wherein the contingent deferred income annuity payment amount is fixed for one or more payments.

3. The method of claim 1, wherein the contingent deferred income annuity payment amount varies with market performance.

4. The method of claim 3, wherein the contingent deferred income annuity payment amount is subject to at least one performance guarantee.

5. The method of claim 1, further comprising determining at least one of a set of expected premium amounts and a set of expected contingent deferred income annuity payment amounts for the at least one participant of the at least one retirement plan or the at least one owner of the at least one individual retirement plan.

6. The method of claim 1, further comprising retrieving contribution data describing contributions that were actually and previously made to the at least one retirement plan or said at least one individual retirement plan by or on behalf of the at least one participant or the at least one owner and using the contribution data to determine at least one of a premium amount and a contingent deferred income annuity payment amount.

7. The method of claim 6, wherein the contribution data excludes roll-over contribution amounts.

8. The method of claim 6, further comprising retrieving rate-of-return data describing rates of return and using the rate-of-return data in determining at least one set of expected returns.

9. The method of claim 8, further comprising determining expected returns prior to the commencement of payments of said contingent deferred income annuity payments.

10. The method of claim 8, further comprising determining expected returns subsequent to commencement of said contingent deferred income annuity payments.

11. The method of claim 5, wherein the specifications must satisfy a requirement that a determined present value of the expected set of premium payments is greater than a determined present value of the expected set of contingent income annuity payments for the at least one participant of the at least one retirement plan or the at least one owner of the at least one individual retirement plan.

12. The method of claim 1, wherein the at least one contingent deferred income annuity contract protecting the at least one participant of the at least one retirement plan or protecting the at least one owner of the at least one individual retirement plan is purchased and held within the at least one retirement plan or within the at least one individual retirement plan.

13. The method of claim 1, wherein the at least one contingent deferred income annuity contract protecting the at least one participant of the at least one retirement plan or protecting the at least one owner of the at least one individual retirement plan is purchased and owned outside of the at least one retirement plan or outside of the at least one individual retirement plan.

14. The method of claim 1, further comprising determining a nominal dollar amount for the contingent deferred income annuity periodic payment amount.

15. The method of claim 1, further comprising:
receiving data regarding an index; and,
retrieving index data on the index and using the index data to determine a nominal dollar amount adjusted by an index for the contingent deferred income periodic payment amount.

16. The method of claim 15, wherein the index is a price index.

17. The method of claim 15, wherein the index is an investment index.

18. The method of claim 15, wherein the nominal dollar amount adjusted by an index is subject to a floor amount.

19. A method comprising:
receiving machine readable input data regarding a determined specification of at least one contingent deferred income annuity contract protecting at least one participant in at least one retirement plan or at least one owner of at least one individual retirement plan and storing the input data in a computer-readable memory;
receiving and storing in a computer-readable memory machine readable data regarding the occurrence of one or more qualifying events causing loss of contributions;
determining whether or not said one or more qualifying events has occurred;
in the event that it is determined no qualifying events have occurred, outputting a determination that no qualifying events have occurred;
in the event that it is determined that one or more qualifying events has occurred, determining amounts and timing for the deferred income annuity payments; and
outputting the determined amounts and timing for the deferred income annuity payments.

20. A method comprising:
receiving machine-readable input data regarding at least one participant in at least one retirement plan or at least one owner of at least one individual retirement plan, and storing the input data in a computer-readable memory;
receiving and storing in a computer-readable memory machine-readable data regarding the probability of occurrences of one or more qualifying events that would cause loss, reduction or suspension of contributions, and the corresponding growth on said contributions to the at least one retirement plan or to the at least one individual retirement plan;
receiving machine-readable data regarding rates of return and storing said input data in said at least one memory;
receiving machine readable data regarding at least one variation of at least one contingent deferred income annuity contract and storing said input data in said at least one memory;
receiving machine readable data regarding at least one alternative variation of at least one contingent deferred income annuity contract, wherein said alternative variation may include no contract, and storing said input data in said at least one memory;
determining, for at least one specified occurrence of the at least one qualifying event, projected deferred income annuity payment amounts for the at least one variation of the at least one contract;
determining, for the at least one specified occurrence of the at least one qualifying event, projected deferred income payment amounts for the at least one alternative variation of the at least one contract; and,
outputting to a graphical output device a graphical comparison of the contingent deferred income annuity amounts for the at least one variation and the at least one alternative variation of the at least one contract.

21. The method of claim 20, further including:
determining, for the at least one specified occurrence of the at least one qualifying event, projected retirement income amounts other than the determined contingent deferred income annuity payment amounts for the at least one variation of the at least one contract;
determining, for the at least one specified occurrence of the at least one qualifying event, projected retirement income amounts other than the contingent deferred income annuity payment amounts for the at least one alternative variation of the at least one contract, and storing the determined data in a computer-readable memory;
determining, for the at least one specified occurrence of the at least one qualifying event, projected retirement income amounts including the determined contingent deferred income annuity payment amounts for the at least one variation of the at least one contract and for the at least one alternative variation of the at least one contract; and
outputting the determined projected retirement income data to the graphical output device a graphical comparison of the determined projected retirement income amounts.

22. The method of claim 1, further comprising storing data on a distributed ledger system, the data comprising one or more selected from the group consisting of: the machine-readable data regarding the at least one participant; the machine-readable data regarding the probability of occurrences of the one or more qualifying events; the machine-readable data regarding rates of return; one or more transactions involving the at least one participant; and one or more transactions regarding the retirement plan or the individual retirement plan.
